(19) United States
(12) Patent Application Publication
(10) Pub. No.: US 2008/0096025 A1
(43) Pub. Date: Apr. 24, 2008

(54) Press molding die and method of manufacturing the same, and magnetic disk glass substrate

(75) Inventor: Hiroshi Minazawa, Nagano (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd., Tokyo (JP)

(21) Appl. No.: 11/898,184

(22) Filed: Sep. 10, 2007

(30) Foreign Application Priority Data
Oct. 24, 2006 (JP) JP 2006-28826

(51) Int. Cl. C03B 40/02; B28B 7/38; B32B 17/06

(52) U.S. Cl. 428/426; 427/133; 65/169

(57) ABSTRACT

A press molding die for a glass material is manufactured by forming an organic compound layer composed of an organic compound having a pyrolysis temperature on the press molding surface of the press molding die; and converting the organic compound layer into a mold release layer by heating to a temperature of at least the pyrolysis temperature of the organic compound. The mold release layer is thus inexpensively provided on the press molding surface, secures excellent releasability of a glass material from the press molding surface of the die, and does not cause unevenness of the press molding surface even upon repeatedly carrying out press molding.

### BACKGROUND OF THE INVENTION

1. Field of the Invention

The present invention relates to a press molding die used in press molding of a glass material for obtaining a magnetic disk glass substrate or the like, a method of manufacturing the press molding die, and a magnetic disk glass substrate manufactured using the press molding die.

2. Description of the Related Art

With magnetic disk apparatuses, for which it is desired to increase the recording density and reduce the cost, random access is realized by scanning with a head flying just above a magnetic disk (magnetic recording medium) rotating at high speed. To achieve both high recording density and high-speed access, it is required to increase the rotational speed of the magnetic disk, and decrease the gap between the magnetic disk and the head (the head flying height). Conventionally, most magnetic disk substrates have been substrates obtained by plating an Al alloy plate with Ni—P. However, in recent years, in particular for mobile magnetic disk apparatuses that are required to be shock resistant, there has been an increasing demand to use, as magnetic disk substrates, glass substrates that have high rigidity and hence do not readily deform even upon rotation at high speed, and moreover can be made to have high surface smoothness. The demand for such glass substrates is in fact currently increasing.

Meanwhile, nowadays magnetic disk apparatuses are also used in home information appliances, and hence the demand for glass substrates is further increasing. It is thus required to secure a good supply of glass substrates, and further reduce the cost. To achieve this, there is an increasingly strong move towards manufacturing glass substrates by pressing. Thus, manufacture of glass substrates has been carried out using a so-called reheat press method. In the reheat press method, a glass material constituting a glass molded article is obtained by melting a starting material so as to produce a glass material, and then reheating this glass material to close to the softening point thereof, and molding by applying pressure using a press molding die, and then cooling, and releasing the glass material from the press molding die by utilizing the difference in thermal contraction there between.

However, in the case of releasing the glass material from the die in a state in which a higher pressure than in the press molding is being applied, much friction arises between the glass molded article and a press molding surface of the press molding die, and, hence, some means must be used to obtain a stable mold release effect. To reduce such friction, it has thus been proposed to dispose a mold release agent between the glass material and the press molding surface.

To promote mold release of a glass molded article from a die, use of a paraffinic oil containing a metal salt of a higher fatty acid as a mold release agent on the press molding surface of the die has been proposed in Japanese Patent Application Laid-open No. 2002-338276 and Japanese Patent Application Laid-open No. 2003-12339. Moreover, in Japanese Patent Application Laid-open No. 2004-131315, using a metal salt of a fatty acid as a mold release agent is proposed and, furthermore, it is disclosed therein that residue of the mold release agent produced on the die surface through the press molding of the glass material is removed so as to prevent the releasability between the die and the glass molded article from deteriorating.

Moreover, in Japanese Patent Application Laid-open No. 2002-338293, using a zinc sulfate aqueous solution as a mold release agent is proposed. Furthermore, in Japanese Patent Application Laid-open No. 2001-172029, using a heat-resistant mold release agent powder such as boron nitride (BN) as a mold release agent is proposed. Moreover, in Japanese Patent Application Laid-open No. 2003-20247, using carbon fine particles including cluster diamond fine particles as a mold release agent is proposed. Furthermore, in Japanese Patent Application Laid-open No. 2004-67423, using a carbon film formed by subjecting a hydrocarbon compound to plasma processing as a mold release agent is proposed, and with regard to the nature of the carbon film, it is stated that amorphous carbon is suitable.

Meanwhile, in the case of a method in which molten glass is directly charged into a molding die, and press molding of a glass optical element having a required shape and a required precision of the surface state is carried out, applying a mold release agent onto the surface of the glass gob before charging the glass gob into the molding die is disclosed in Japanese Patent Application Laid-open No. H6-305740. It is also stated therein that a carbonaceous powder obtained through combustion of a hydrocarbon is used as the mold release agent.

However, in the case of using a mold release agent as described above in Japanese Patent Application Laid-open No. 2002-338276, Japanese Patent Application Laid-open No. 2003-12339, and Japanese Patent Application Laid-open No. 2004-131315, a metal component of the mold release agent remains on the press molding surface of the press molding die after the press molding so that the die must be cleaned periodically in order to obtain glass molded articles having a smooth surface on a continuing basis. Moreover, in the case of using the mold release agent as described above in Japanese Patent Application Laid-open No. 2002-338293, moisture in the mold release agent evaporates through heating during the press molding so that the zinc sulfate crystallizes and unevenness arises on the press molding surface due to this crystallized zinc sulfate. If press molding of a glass material is carried out repeatedly in this state, concave defects arise on the surface of the glass material and, hence, the surface cannot be made to be smooth. Furthermore, if the mold release agent as described above in Japanese Patent Application Laid-open No. 2001-172029 is used, a component of the mold release agent similarly remains so that unevenness arises on the die surface and, hence, the die must be cleaned frequently and periodically to obtain glass molded articles having a smooth surface form through the press molding only.

Furthermore, because the mold release agent described above in Japanese Patent Application Laid-open No. 2003-20247 contains diamond, the mold release agent itself is expensive and, hence, the press molding cost increases so that keeping down the manufacturing cost of the article manufactured by the press molding is difficult. Furthermore, because the mold release agent described above in Japanese Patent Application Laid-open No. 2004-67423 is formed by subjecting a hydrocarbon compound to plasma processing, it is difficult to produce the mold release agent inexpensively.

Moreover, the mold release agent described in Japanese Patent Application Laid-open No. H6-305740 is a carbonaceous powder and is applied directly onto the surface of the glass gob, thus, it is doubtful whether good releasability between the press molding surface of the die and the glass gob can be suitably secured.

### SUMMARY OF THE INVENTION

In view of the above problems, it is thus an object of the present invention to inexpensively provide, on a press molding surface of a die, a mold release layer that secures excellent releasability of a glass material, i.e., a glass molded article, from the press molding surface and, moreover, does not cause unevenness of the press molding surface even upon repeatedly carrying out press molding.

To attain the above object, the present invention provides a method of manufacturing a press molding die having a press molding surface for a glass material, the method comprising the steps of a first step of forming an organic compound layer comprised of an organic compound on the press molding surface of the press molding die; and a second step of converting the organic compound layer into a mold release layer by heating to a temperature of at least a pyrolysis temperature of the organic compound.

The organic compound is preferably composed of carbon and at least one element selected from the group consisting of hydrogen, oxygen and nitrogen.

The mold release layer is preferably formed to an average thickness ranging from 50 to 100 nm on the press molding surface in the second step.

Moreover, the second step is preferably carried out in a non-oxidizing atmosphere.

The glass material may be a glass material for a magnetic disk glass substrate.

Moreover, to attain the above object, a press molding die of the present invention is characterized by being manufactured using a method of manufacturing a press molding die as described above.

Furthermore, the present invention also provides a magnetic disk glass substrate manufactured by a reheat press method using a press molding die as described above.

According to the present invention, a mold release layer is inexpensively provided on the press molding surface, secures excellent releasability of a glass material from the press molding surface of the die, and does not cause unevenness of the press molding surface even upon repeatedly carrying out press molding.

### BRIEF DESCRIPTION OF THE DRAWING

FIG. 1 is a schematic structural view illustrating an example of a magnetic disk glass substrate manufacturing apparatus.

### DETAILED DESCRIPTION OF THE INVENTION

The following is a description of various embodiments of the present invention. In the following, an embodiment in which a magnetic disk glass substrate is manufactured by press molding using a press molding die is described.

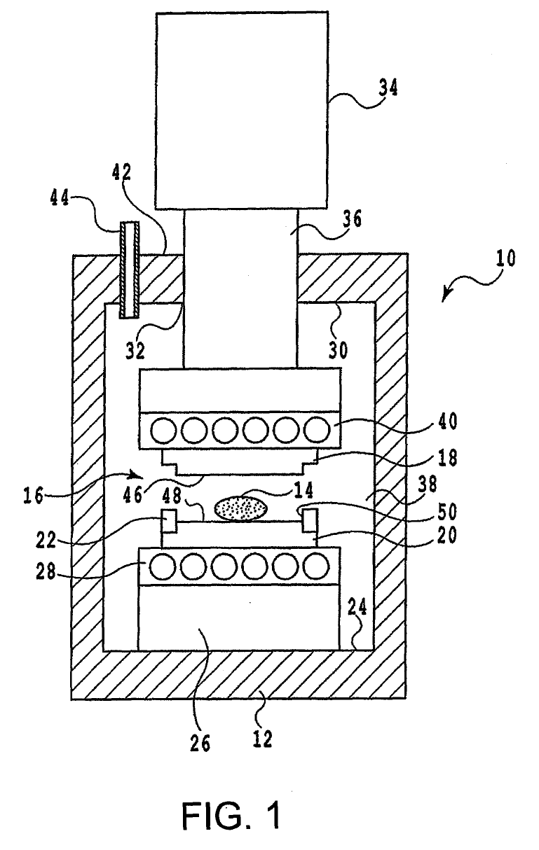

FIG. 1 is a schematic structural view of a magnetic disk glass substrate manufacturing apparatus 10 used in the manufacture of a magnetic disk glass substrate. The manufacturing apparatus 10 has a pressing chamber 12. Although not shown, provided in a side wall of the pressing chamber 12 are openings for conveying a glass material 14 in and out, and shutters for opening and closing the respective openings. The manufacturing apparatus 10 may also be made to have a preheating chamber and a cooling chamber for the glass material before and after the pressing chamber 12, respectively, and, furthermore, may be made to have an apparatus for conveying the glass material into and out of these chambers.

The pressing chamber 12 is for press molding the glass material 14 that has been conveyed therein, and has disposed therein a press molding die (hereinafter “die”) 16. The die 16 comprises an upper die member 18 which is an upper die, and a lower die member 20 which is a lower die. In the present embodiment, the die 16 also has a constraining ring 22 provided on the lower die member 20, but this need not be provided. The die 16 may be constituted from pairing the upper die member 18 and the lower die member 20.

A stage 26 is provided on an interior bottom surface 24 of the pressing chamber 12, and a heater block 28 is provided on an upper portion thereof. The lower die member 20 is installed facing upward on an upper side of the heater block 28. On the other hand, an opening 32 is formed in an interior top surface 30 of the pressing chamber 12, and a cylinder 36 that is directly connected to a pressing machine 34 passes from the opening 32 into the interior 38 of the pressing chamber 12. A heater block 40 is connected to a tip of the cylinder 36 positioned inside the pressing chamber 12, and the upper die member 18 is installed facing downward on a lower side of the heater block 40. Furthermore, when press molding is carried out, dry nitrogen gas from a nitrogen gas tank (not shown) is introduced into the interior 38 of the pressing chamber 12 from a nitrogen gas introducing pipe 44 that passes through a ceiling 42 of the pressing chamber 12 so that a nitrogen gas atmosphere is formed. Note that the nitrogen gas is used so that the press molding and the formation of mold release layers, described below, are carried out in a non-oxidizing atmosphere, and hence an inert gas, such as argon gas or helium gas, may be used instead of the nitrogen gas.

Next, the press molding die 16 for the glass material will be described. The two surfaces of the die 16 where the upper die member 18 and the lower die member 20 face one another are each covered with a protective film, and, moreover, a mold release layer is further formed on each of these surfaces. In the state in which the mold release layers have been formed, press molding surfaces 46 and 48 formed on the protective films on the upper die member 18 and the lower die member 20, respectively, are thus essentially formed on the respective mold release layer. The press molding surface 46, which is the lower surface of the upper die member 18, and the press molding surface 48, which is the upper surface of the lower die member 20, face one another as is clear from FIG. 1. During press molding, a sealed cavity, i.e., a closed space, is formed by the press molding surfaces 46 and 48, and an inner peripheral surface 50 of the constraining ring 22.

In the present embodiment, the main bodies of the die 16, i.e., the main body of each of the upper die member 18 and the lower die member 20, are made of an ultra-hard alloy having tungsten carbide (WC) as a main component thereof, cobalt (Co) being used as a binder in this ultra-hard alloy. Moreover, the protective film formed on the surface of each main body is preferably formed from a material that has poor wettability to the glass material 14 at high temperature, i.e., is chemically inert to the glass material 14, so as to protect the main body of the die 16 and, in the present embodiment, is formed from platinum (Pt). In the present embodiment, each protective film is formed to a thickness of approximately 1 μm by sputtering. Moreover, in the present embodiment, the surface roughness of each protective film is made to be not more than 100 nm in terms of the center line average height. That is, the press molding surfaces 46 and 48 of the upper die member 18 and the lower die member 20 facing one another are smoothed to a predetermined level.

Each protective film preferably has a composition comprising at least one element selected from silicon (Si), nickel (Ni), chromium (Cr), titanium (Ti), niobium (Nb), vanadium (V), molybdenum (Mo), platinum (Pt), palladium (Pd), iridium (Ir), rhodium (Rh), osmium (Os), ruthenium (Ru), rhenium (Re), tungsten (W) and tantalum (Ta), or an alloy having one of the above as a main component thereof, or at least one compound selected from alumina (Al₂O₃), silicon carbide (SiC), chromium carbide (Cr₃C₂), chromium oxide (Cr₂O₃), silicon nitride (Si₃N₄) and boron nitride (BN). Moreover, the thickness of each protective film is not limited to being as above, but rather may be any thickness so long as the film acts as a protective film. Furthermore, any film formation method may be used for the protective films.

The mold release layer that constitutes part of the die 16 and is formed on each of the press molding surfaces 46 and 48 of the die 16 will now be described. Each mold release layer is formed on an outer surface of the respective protective film, and reduces friction between the surface of the protective film and the surface of the glass material 14 during the press molding. As a result, sufficient releasability of the molded article obtained by the molding of the glass material 14 can be secured. Each mold release layer is formed as a pyrolyzed layer obtained by heating a layer comprising an organic compound to at least the pyrolysis temperature of the organic compound. Note that the mold release layer obtained by pyrolyzing the organic compound preferably does not combust at a temperature below the press molding temperature during the press molding.

The mold release layer is formed on each of the press molding surfaces 46 and 48 via predominantly two steps. One of these two steps is a first step of forming an organic compound layer on each of the press molding surfaces 46 and 48 of the die 16. The other of the two steps is then a second step of converting each organic compound layer formed through the first step into a mold release layer by heating to at least the pyrolysis temperature of the organic compound (this being a temperature less than the combustion temperature). Due to being formed via these steps, each mold release layer has amorphous carbon as a main component thereof.

In the first step, a layer of an organic compound composed of carbon, and at least one element selected from the group consisting of hydrogen, oxygen and nitrogen is formed on each of the press molding surfaces 46 and 48 of the die 16. As is clear from the experimental results described later, the organic compound used here is most preferably composed of carbon, and at least one element selected from the group consisting of hydrogen, oxygen and nitrogen. The organic compound layer is formed on each of the press molding surfaces 46 and 48 with the press molding surfaces 46 and 48 at a temperature below the pyrolysis temperature of the organic compound. Specifically, in the case that the organic compound is a liquid, the organic compound having a composition as above is directly or indirectly applied onto each of the press molding surfaces 46 and 48 with the press molding surfaces 46 and 48 at such a temperature, whereby the organic compound layer is formed. Note, however, that in the case of a liquid, the applied organic compound must not vaporize at a temperature below the pyrolysis temperature thereof at atmospheric pressure, so that the organic compound layer can be formed on each of the press molding surfaces 46 and 48 continuously. Alternatively, in the case that the organic compound is a solid (including a powder), the organic compound composed as above is deposited uniformly by spraying or the like on each of the press molding surfaces 46 and 48 with the press molding surfaces 46 and 48 at such a temperature, whereby the organic compound layer can be formed. Note, however, that in the case of a solid, the organic compound must not vaporize at a temperature below the pyrolysis temperature thereof at atmospheric pressure, but may become liquid. In any case, the organic compound layer formed on each of the press molding surfaces 46 and 48 at a temperature not more than the pyrolysis temperature of the organic compound and at atmospheric pressure must persist up to the second step. Moreover, regardless of whether the organic compound constituting the starting material of the mold release layers is a liquid or a solid, the organic compound may also be dissolved in a volatile organic solvent in which the organic compound is soluble, such as ethanol, and then applied by spraying, dipping, spin coating or the like, whereby a layer can be formed on each of the press molding surfaces 46 and 48 by evaporating off the solvent. The thickness of each organic compound layer thus formed can be measured using suitably calibrated ellipsometry or a high sensitivity reflection method using a Fourier transform infrared spectrophotometer or the like.

Next, in the second step, the organic compound layer formed on each of the press molding surfaces 46 and 48 through the first step is converted into a mold release layer by being heated to at least the pyrolysis temperature of the organic compound. As a result, a die 16 in which such a mold release layer is formed on each of the press molding surfaces 46 and 48 can be obtained. This second step may be carried out unrelated to the press molding, or may be carried out accompanying heating of the die 16 for the press molding. That is, prior to the press molding, the die 16 having an organic compound layer formed on each of the press molding surfaces 46 and 48 may be heated to the pyrolysis temperature of the organic compound separate to the heating during the press molding so as to convert the organic compound layers and thus form the mold release layers. Alternatively, the mold release layers may be formed by the organic compound layers being heated to at least the pyrolysis temperature of the organic compound accompanying the die 16 being heated to the press molding temperature in a state with the glass material 14 disposed between the press molding surfaces 46 and 48. Analysis of the pyrolysate produced through the pyrolysis of the organic compound and measurement of the thickness can be carried out by cross sectional observation using a transmission electron microscope or by Raman spectroscopy.

Next, an example of formation of the mold release layers and press molding of the glass material 14 using the die 16 having the mold release layers formed thereon will be described with reference to FIG. 1. Note that here, the mold release layers are formed accompanying heating of the die for the press molding.

In a state with the press molding surfaces 46 and 48 of the die 16 disposed separated from one another as shown in FIG. 1, a solution of tricosane (C₂₃H₄₈) which is an organic compound in a volatile organic solvent is manually applied onto the press molding surfaces 46 and 48. At this time, the die 16 has a temperature below the pyrolysis temperature of the tricosane, and is not in a non-oxidizing atmosphere. The solvent is then evaporated off so as to form a layer comprising the tricosane on each of the press molding surfaces 46 and 48, and then in this state the glass material 14 is placed on the lower die member 20.

After the formation of the tricosane layers and the placement of the glass material 14, the pressing chamber 12 is closed, and nitrogen gas from the nitrogen gas introducing pipe 44 is introduced into the interior 38 of the pressing chamber 12, so as to sufficiently replace the atmosphere with a nitrogen gas atmosphere. Gas, such as air that was in the pressing chamber 12 up to now, is discharged via a hole (not shown) formed in a wall of the pressing chamber 12 in an amount which is proportional to the introduced nitrogen gas. By introducing a sufficient amount of the nitrogen gas, the atmosphere of the interior 38 of the pressing chamber 12 can thus be suitably replaced with a non-oxidizing atmosphere. Note that in the case a separate apparatus is provided so that movement of the glass material 14 in the sealed interior 38 and formation of the tricosane layers can be carried out through manual or automatic operation of this apparatus, the formation of the tricosane layers and the movement and placement of the glass material 14 may be carried out after the interior 38 has been replaced with the nitrogen gas atmosphere in advance. Moreover, in the case that the organic compound for forming the organic compound layers does not vaporize in a vacuum, the pressing chamber 12 having disposed therein the die having the organic compound layers formed thereon may be first put into a vacuum state using an externally provided vacuum pump via the nitrogen gas introducing pipe 44, and then replacement with a nitrogen gas atmosphere may be carried out by introducing nitrogen gas.

As described above, a tricosane layer is formed, i.e., an organic compound layer is formed, on each of the press molding surfaces 46 and 48 of the die 16, a glass material is placed between the press molding surfaces 46 and 48, the pressing chamber 12 is replaced with a nitrogen gas atmosphere, and then in this state, heating is carried out using the heater blocks 28 and 40. Here, the glass material 14 is an aluminosilicate glass having a softening point of 625° C., and hence the die 16 and the glass material 14 are heated to a press molding temperature of 600° C. using the heater blocks 28 and 40. The pyrolysis temperature of tricosane is below 600°, and, hence, through heating up to the press molding temperature, the tricosane of the tricosane layers is pyrolyzed. In this way, the organic compound layer comprising tricosane on each of the press molding surfaces 46 and 48 is converted into a mold release layer, whereby a mold release layer is formed on each of the press molding surfaces 46 and 48 prior to the press molding.

Then, the cylinder 36 is advanced using the pressing machine 34, whereby the glass material 14 is pressed at a predetermined pressure to a predetermined thickness. After that, the heating by the heater blocks 28 and 40 is stopped so as to carry out cooling, whereby mold release of the glass material 14 from the die 16 is promoted. Upon the completion of the mold release, a molded article of the glass material 14, i.e., a magnetic disk glass substrate, is obtained. Note that the manufacturing method in which a glass material 14 produced by melting a starting material is reheated and subjected to press molding as described above is referred to as “reheat pressing”.

To demonstrate the mold release layer formation method and the effects of the present invention as described above, various experiments were carried out. The results of these experiments are described below.

First, a first experiment will be described. This experiment was carried out to investigate the properties of an organic compound suitable for obtaining a mold release layer. In this experiment, dies 16 having mold release layers formed using two different organic compounds were prepared. In the following description, the case that pentadecane (C₁₅H₃₂) was used as the organic compound is taken as Example A, and the case that tricosane (C₂₃H₄₈) was used as the organic compound is taken as Example B. In the following, the reference numerals for the different constituent components manufactured and used in the respective examples are appended with the symbol “a” in the case of Example A, and “b” in the case of Example B. That is, the die 16 of Example A is appended with “a”, and thus referred to as the “die 16a”. Note that both of the organic compounds pentadecane and tricosane are saturated hydrocarbon compounds.

In Example A, a layer comprising pentadecane was formed on each of the press molding surfaces 46a and 48a of the die 16a to a uniform thickness of 500 nm. In this Example A, first a solution was prepared by dissolving the pentadecane in a volatile organic solvent in which the pentadecane is soluble, such as ethanol, and the solution was applied onto the press molding surfaces 46a and 48a by spraying. After that, the solvent was evaporated of, whereby a layer comprising pentadecane was formed on each of the press molding surfaces 46a and 48a.

On the other hand, in Example B, a layer comprising tricosane was formed on each of the press molding surfaces 46b and 48b of the die 16b to a uniform thickness of 500 nm using the same procedure as in Example A described above.

Each of the dies 16a and 16b of Examples A and B having the organic compound layers formed thereon in this way was then heated to press molding temperature in a nitrogen gas atmosphere. An aluminosilicate glass having a softening point of 625° C. was used as the glass material 14 and, hence, considering the temperature-viscosity characteristics thereof, the press molding temperature was made to be 600° C. Moreover, the heating time was made to be 10 minutes. Each of the dies 16a and 16b having the organic compound layers formed thereon was thus heated to 600° C., and was then held at this temperature by heating for 10 minutes. After that, sufficient cooling was carried out whereby dies 16a and 16b having mold release layers formed thereon were obtained.

The mold release layers of the dies 16a and 16b were investigated. Upon investigating the surfaces of the die 16a of Example A, there was hardly any pyrolysate, and hence hardly any matter that could be described as a mold release layer was present on the protective films of the die 16a. This is thought to be because the boiling point of pentadecane is 271° C., and hence the pentadecane evaporated during the heating to the press molding temperature. On the other hand, upon investigating the surfaces of the die 16b of Example B, there was a mold release layer comprising predominantly amorphous carbon on each of the protective films. This is thought to be because the tricosane used in Example B does not have a boiling point under atmospheric pressure and, hence, was present on the press molding surfaces 46b and 48b of the die 16b up to the pyrolysis temperature. It is thus thought that pyrolysis of the tricosane took place during the heating up to the press molding temperature and, hence, a layer comprising the pyrolysate amorphous carbon was formed as a mold release layer on each of the press molding surfaces 46b and 48b. Note that analysis and measurement of the pyrolysate were carried out by cross sectional observation using a transmission electron microscope.

Using the dies 16a and 16b having mold release layers provided thereon in this way, press molding of a glass material 14 was carried out. The glass material 14 used in the experiment was made of aluminosilicate glass as described above, and in the experiment was made to be a sphere of diameter 7.67 mm. The press molding was carried out under the same conditions for Examples A and B. The procedure of the press molding for Example A will thus be described here, with description of the procedure of the press molding for Example B being omitted. In Example A, the glass material 14 was placed between the upper die member 18a and the lower die member 20a, and the upper die member 18a and the lower die member 20a were heated to the press molding temperature of 600° C., and then press molding of the glass material 14 was carried out at a pressure of 450 kgf/cm² to a thickness of 0.4 mm. After that, cooling to approximately 200° C. was carried out and then the glass molded article manufactured through the press molding, i.e., a magnetic disk glass substrate, was taken out.

The above press molding was carried out repeatedly on a plurality of pieces of the glass material 14 for each of Examples A and B. The results were that for Example A, as the press molding was repeated, attachment of the glass material 14 to the die 16a, cracking of the glass material 14 and so on, became progressively more severe. In contrast, for Example B, even upon repeating the press molding, such things were not seen to happen to the glass material 14 through the press molding, but rather good magnetic disk glass substrates could be obtained. That is, it was ascertained that whereas good releasability was not obtained in Example A, the mold release layers in Example B had excellent releasability.

From the above, through the first experiment, it was ascertained that converting an organic compound layer by pyrolysis so as to form a mold release layer is effective. Moreover, it was shown that the organic compound must not vaporize at a temperature below the pyrolysis temperature.

Next, a second experiment will be described. This experiment was carried out to investigate a suitable thickness for the mold release layers. In this experiment, tricosane, which was used for Example B in the first experiment, was used as the organic compound. As in the first example described above, layers comprising tricosane were pyrolyzed so as to provide mold release layers on the die 16. In the present second experiment, three dies 16 having mold release layer average thicknesses of 50 nm, 100 nm, and 500 nm were prepared. In the following description, the case that mold release layers of average thickness 50 nm were provided is taken as Example C, the case that mold release layers of average thickness 100 nm were provided is taken as Example D, and the case that mold release layers of average thickness 500 nm were provided is taken as Example E. Moreover, in the following, similarly to in the first experiment, the reference numerals for the different constituent components in the respective examples are appended with “c” in the case of Example C, “d” in the case of Example D, and “e” in the case of Example E.

In Examples C, D, and E, respectively, press molding of the above glass material 14 made of aluminosilicate glass was carried out using the die 16c, 16d, or 16e. The pressing conditions were made to be the same as in the first experiment. As a value indicating the degree of flatness of the surface of the magnetic disk glass substrate obtained through the press molding, arithmetic mean waviness Wa of the surface was investigated and the releasability of the glass material 14 from the die 16 was evaluated. Note that in view of the increase in recording density and decrease in head flying height for magnetic disks, it is preferable for the arithmetic mean waviness Wa of the surface of a magnetic disk glass substrate to be less than 50 nm.

The results of the investigation were that the arithmetic mean waviness Wa of the surface of the magnetic disk glass substrates manufactured using the dies 16c and 16d of Examples C and D was less than 50 nm. In contrast, the arithmetic mean waviness Wa of the surface of the magnetic disk glass substrates manufactured using the die 16e of Example E was not less than 50 nm. It was thus ascertained that good glass substrates can be obtained by making the average thickness of the mold release layers formed as described above be from 50 to 100 nm.

Next, a third experiment will be described. This experiment was carried out to investigate how the mold release layers should be formed. In this experiment, tricosane, which was shown to be effective from the first experiment, was used as the organic compound. In the present third experiment, two dies 16 having mold release layers formed thereon using different methods were prepared. The difference between these was that, in one, the organic compound layers were formed on a die 16 that had been heated to at least the pyrolysis temperature of the organic compound whereas in the other, the organic compound layers were formed on a die 16 at a temperature below the pyrolysis temperature of the organic compound as in the first and second experiments described above. In the following description, the case that the organic compound layers were formed using the former method is taken as Example F and the case that the organic compound layers were formed using the latter method is taken as Example G. Moreover, in the following, similarly to for the first and second experiments, the reference numerals for the different constituent components in the respective examples are appended with “f” in the case of Example F and “g” in the case of Example G.

In Example F, a die 16f having neither organic compound layers nor mold release layers formed thereon was heated to 500° C., which is a temperature above the pyrolysis temperature of tricosane, in a nitrogen gas atmosphere and, then, a solution of tricosane in a volatile organic solvent was applied onto the press molding surfaces 46f and 48f. The tricosane pyrolyzed immediately after the application. In this Example F, the solution was applied such that the average thickness of the mold release layers produced through the pyrolysis of the tricosane was 100 nm.

On the other hand, in Example G, as in Example D described above, a layer comprising tricosane was formed on each of the press molding surfaces 46g and 48g of a die 16g having a temperature below the pyrolysis temperature of tricosane. The die 16g was then heated to 600° C., which is above the pyrolysis temperature, whereby a mold release layers of average thickness 100 nm was formed on each of the press molding surfaces 46g and 48g.

Using the dies 16f and 16g having mold release layers formed thereon in this way, magnetic disk glass substrates were manufactured by press molding a glass material 14 as in the second experiment described above and the surface form was investigated. The results were that, as for Example D described above, for Example G a magnetic disk glass substrate having a surface with an arithmetic mean waviness Wa of less than 50 mm could be obtained. In contrast, for Example F, the arithmetic mean waviness Wa of the surface of the magnetic disk glass substrate manufactured was not less than 50 nm. This is conjectured to be because due to the solution containing the tricosane being applied onto the press molding surfaces 46f and 48f at a temperature above the pyrolysis temperature of the tricosane, the mold release layers could not be made to have a uniform thickness.

From the present third experiment, it was ascertained that it is preferable to form the organic compound layer on each of the press molding surfaces 46 and 48 of the die 16 at a temperature below the pyrolysis temperature of the organic compound.

Next, a fourth example will be described. This experiment was carried out to investigate what constituent elements the organic compound is preferably made to have for obtaining the mold release layers. In this experiment, mold release layers were formed using four organic compounds. In the following description, the case that pentadecyl alcohol (C₁₅H₃₂O), which is a saturated hydrocarbon type alcohol, was used as the organic compound is taken as Example H; the case that stearyl amine (C₁₈H₃₉N), which is a saturated hydrocarbon type amine, was used as the organic compound is taken as Example; the case that tetracosanoic acid (C₂₄H₄₈O₂), which is a saturated hydrocarbon type carboxylic acid, was used as the organic compound is taken as Example; and the case that sodium tetracosanoate (C₂₄H₄₇O₂Na), which is a sodium salt of a saturated hydrocarbon type carboxylic acid, was used as the organic compound is taken as Example K. Moreover, in the following, similarly to in the first experiment, the reference numerals for the different constituent components in the respective examples are appended with “h” in the case of Example H, “i” in the case of Example I, “j” in the case of Example J, and “k” in the case of Example K.

For each of Examples H to K, as for Example D described above, layers comprising the respective organic compound were formed on a die 16h, 16i, 16j, or 16k having a temperature below the pyrolysis temperature of that organic compound. The die was then heated to 600° C. which is above the pyrolysis temperature, whereby mold release layers of average thickness 100 nm were formed on the press molding surfaces 46h and 48h, 46i and 48i, 46j and 48j, or 46k and 48k of the die 16h, 16i, 16j, or 16k, respectively.

Using each of the dies 16h, 16i, 16j, and 16k having mold release layers formed thereon in this way, magnetic disk glass substrates were manufactured by press molding a glass material 14 as in the second experiment described above. The press molding was carried out a plurality of times for each of Examples H, I, J, and K, and the surface form of the magnetic disk glass substrates obtained was investigated. The results were that for Examples H, I, and J, magnetic disk glass substrates having a surface with an arithmetic mean waviness Wa of less than 50 nm could be continuously obtained. In contrast, for Example K, the arithmetic mean waviness Wa of the surface of the magnetic disk glass substrate became not less than 50 nm. This is because the press molding surfaces 46k and 48k progressively lost their flatness as the number of times of press molding increased. The reason that the press molding surfaces 46k and 48k lost their flatness as the number of times of press molding increased in this way is thought to be that the organic compound in Example K contains sodium (Na), and this remained as a residue after the decomposition of the organic compound at the pyrolysis temperature, forming unevenness on the press molding surfaces. Note also that, although detailed description will not be given here, the same happens in the case that the organic compound contains another metallic element. Moreover, in the case that the organic compound contains a halogen such as fluorine (F) or chlorine (Cl), the protective films are corroded by the halogen and, hence, if mold release layers are formed using such an organic compound and press molding is carried out repeatedly, then the press molding surfaces progressively lose their smoothness. For this reason, it is similarly undesirable to obtain magnetic disk glass substrates by press molding using a die having mold release layers formed thereon using such organic compounds.

From the above, according to the fourth experiment, it was ascertained that it is preferable to use an organic compound not containing a metallic element or a halogen as the organic compound for obtaining the mold release layers. Such an organic compound is, in other words, an organic compound composed of only a combination of elements selected from the group consisting of carbon, hydrogen, oxygen, and nitrogen. For example, such organic compounds include docosane (C₂₂H₄₆), tetracosane (C₂₄H₅₀), pentacosane (C₂₅H₅₂), and hexacosane (C₂₆H₅₄).

According to the first to fourth experiments described above, it was shown that a mold release layer having excellent releasability, cleanliness, and so on can be provided on each of the press molding surfaces 46 and 48 of the die 16 by forming an organic compound layer composed of carbon, and at least one element selected from the group consisting of hydrogen, oxygen and nitrogen, and then converting the organic compound layer by heating to at least the pyrolysis temperature of the organic compound. Moreover, the heating to at least the pyrolysis temperature of the organic compound is preferably carried out in a non-oxidizing atmosphere as in the above experiments so as to prevent unintended reactions of the organic compound from occurring.

By providing an organic compound layer on each press molding surface and heating to at least the pyrolysis temperature in this way, a mold release layer having excellent releasability can be formed, and hence the mold release layer itself can be produced inexpensively. A magnetic disk glass substrate manufactured using a die having such mold release layers thereon is thus inexpensive. Moreover, by using a die having such mold release layers thereon, glass molded articles having an excellent surface form can be obtained even upon carrying out press molding repeatedly, and hence it is clear that the mold release layers are suitable for mass production. More specifically, a magnetic disk glass substrate having an excellent surface form can be manufactured through the reheat press method using a die having such mold release layers thereon and, hence, magnetic disk glass substrates can be mass produced inexpensively.

It is understood that various other modifications will be apparent to and can be readily made by those skilled in the art without departing from the scope and spirit of the present invention. Accordingly, it is not intended that the scope of the claims appended hereto be limited to the description set forth above but rather that the claims be construed as encompassing all of the features of patentable novelty which reside in the present invention, including all features which would be treated as equivalents thereof by those skilled in the art to which the invention pertains.

What is claimed is:

1. A method of manufacturing a press molding die having a press molding surface for a glass material, the method comprising the steps of:
forming an organic compound layer comprised of an organic compound having a pyrolysis temperature on the press molding surface of the press molding die; and
converting the organic compound layer into a mold release layer by heating to a temperature of at least the pyrolysis temperature of the organic compound.

2. The method according to claim 1, wherein the mold release layer has an average thickness ranging from 50 to 100 nm.

3. The method according to claim 1, wherein pyrolyzing is carried out in a non-oxidizing atmosphere.

4. The method according to claim 1, wherein the glass material is a glass material suitable for a magnetic disk glass substrate.

5. The method according to claim 1, wherein the organic compound is composed of carbon and at least one element selected from the group consisting of hydrogen, oxygen and nitrogen.

6. The method according to claim 5, wherein the mold release layer has an average thickness ranging from 50 to 100 nm.

7. The method according to claim 6, wherein pyrolyzing is carried out in a non-oxidizing atmosphere.

8. The method according to claim 5, wherein pyrolyzing is carried out in a non-oxidizing atmosphere.

9. The method according to claim 5, wherein the glass material is a glass material suitable for a magnetic disk glass substrate.

10. A press molding die for a glass material which has a press molding surface provided with a mold release layer which is suitable for releasing the glass material, and which is manufactured using a method of manufacturing a press molding die comprising the steps of:
forming an organic compound layer comprised of an organic compound having a pyrolysis temperature on the press molding surface of the press molding die; and
converting the organic compound layer into a mold release layer by heating to a temperature of at least the pyrolysis temperature of the organic compound.

11. The press molding die according to claim 10, wherein the mold release layer has an average thickness ranging from 50 to 100 nm.

12. The press molding die according to claim 10, wherein pyrolyzing is carried out in a non-oxidizing atmosphere.

13. The press molding die according to claim 10, wherein the glass material is a glass material suitable for a magnetic disk glass substrate.

14. The press molding die according to claim 10, wherein the organic compound for forming the organic compound layer is composed of carbon and at least one element selected from the group consisting of hydrogen, oxygen and nitrogen.

15. The press molding die according to claim 14, wherein the mold release layer has an average thickness ranging from 50 to 100 nm.

16. The press molding die according to claim 15, wherein pyrolyzing is carried out in a non-oxidizing atmosphere.

17. The press molding die according to claim 14, wherein pyrolyzing is carried out in a non-oxidizing atmosphere, and wherein the mold release layer is comprised of amorphous carbon.

18. The press molding die according to claim 14, wherein the glass material is a glass material suitable for a magnetic disk glass substrate.

19. A magnetic disk glass substrate manufactured by a reheat press method using a press molding die for a glass material which has a press molding surface provided with a mold release layer which is suitable for releasing the glass material, and which is manufactured using a method of manufacturing a press molding die comprising the steps of:
forming an organic compound layer comprised of an organic compound having a pyrolysis temperature on the press molding surface of the press molding die; and
converting the organic compound layer into a mold release layer by heating to a temperature of at least the pyrolysis temperature of the organic compound.

20. The magnetic disk substrate according to claim 19, wherein the organic compound for forming the organic compound layer is composed of carbon and at least one element selected from the group consisting of hydrogen, oxygen and nitrogen, wherein pyrolyzing is carried out in a non-oxidizing atmosphere, and wherein the mold release layer is comprised of amorphous carbon.
